(19) United States
(12) Patent Application Publication
(10) Pub. No.: US 2009/0327754 A1
(43) Pub. Date: Dec. 31, 2009

(54) COMMUNICATIONS TERMINAL, STORAGE MEDIUM STORING COMMUNICATION TERMINAL CONTROLLING PROGRAM, COMMUNICATION TERMINAL CONTROLLING METHOD, STORAGE MEDIUM STORING COMMUNICATION CONTROLLING PROGRAM AND AUTHENTICATION SYSTEM

(75) Inventor: Takuya Sato, Osaka (JP)

Correspondence Address: PROCOPIO, CORY, HARGREAVES & SAVITCH LLP, 530 B STREET, SUITE 2100, SAN DIEGO, CA, 92101, US

(73) Assignee: KYOCERA CORPORATION, Kyoto (JP)

(21) Appl. No.: 12/490,184

(22) Filed: Jun. 23, 2009

(30) Foreign Application Priority Data
Jun. 26, 2008 (JP) 2008-167054

(51) Int. Cl. H04L 9/28; G06F 15/16; H04L 9/00

(52) U.S. Cl. 713/189; 709/206; 380/44

(57) ABSTRACT

A communication terminal 10 includes a RAM 32, and the RAM 32 stores common key data (340). When an arbitrary file is attached to e-mail to which an e-mail address is set, a CPU 20 performs a process to create an encryption key from the data of the e-mail address of an opponent to be sent and common key data, to encrypt the file to be attached therewith. Then, the encrypted file is attached to the e-mail, and the e-mail attached with the encrypted file is sent.

### CROSS REFERENCE TO RELATED APPLICATION

The present application claims priority to Japanese patent application number 2008-167054 filed Jun. 26, 2008, which is incorporated herein by reference in its entirety.

### FIELD OF THE INVENTION

The present invention relates to a communication terminal, a storage medium storing a communication terminal controlling program, a communication terminal controlling method, a storage medium storing a communication controlling program, and an authentication system. More specifically, the present invention relates to a communication terminal, a storage medium storing a communication terminal controlling program, a communication terminal controlling method, a storage medium storing a communication controlling program, and an authentication system which are able to encrypt a sent file.

### BACKGROUND

One example of the related art of such a kind is disclosed in the Japanese Patent Application Laid-Open No. 2005-285111 [G06F 13/00] laid-open on Oct. 13, 2005. This related art is an electronic mail sending method in which when electronic mail is sent with an attached file attached, conversion processing is performed on the attached file by taking a character string set by a sender in advance as a password, and the resultant is sent to an opponent. This conversion processing includes encryption processing or compression processing. Thus, the receiver who is not informed of the password as an encryption key before and after sending cannot decrypt and open the encrypted attached file. Thus, in a case that wrong sending occurs, it is possible to prevent the data sent as an attached file from being leaked.

Furthermore, in the related art disclosed in Japanese Patent Application Laying-Open No. 2006-301887 [G06F 21/24, H04L 9/08] laid-open on Nov. 2, 2006, in order to prevent downloaded content data from being illegally copied, the downloaded content data is encrypted with the use of a key created based on a phone number of a mobile terminal. Since this encryption system utilizing a phone number as a key, this is called a “phone number bind”, and the downloaded content data cannot be decrypted and created by a mobile terminal with a different phone number.

In addition, in the related art disclosed in Japanese Patent Application Laying-open No. 2003-8567 [H04L 9/10, G06F 12/14, H04L 9/08] laid-open on Jan. 10, 2003, a digital content is recorded or reproduced by utilizing an encryption key relying on an ID (identification information) peculiar to a recording medium. Since this encryption system uses an ID peculiar to the recording medium as an encryption key, this is called a “media bind”, and even if the digital content data is entirely copied to another recording medium different in the ID, the digital content data cannot be decrypted or reproduced.

However, in the first related art, it is necessary to separately inform a receiver of a password when a file is encrypted, taking a lot of trouble for the sender. Furthermore, in a case that the receiver erroneously lets out a password together with an encrypted file, anyone can refer to the content of the encrypted file as a result. In addition, in a case that the receiver decrypts an encrypted file with a PC, easiness of storing a decrypted file involves a risk of the receiver transferring the decrypted file to others.

On the other hand, in the second and the third related arts, the content data is protected by the “phone number bind” or the “media bind”, but the reading of the data is limited to its own mobile terminal or a specific recording medium, being short of versatility.

### SUMMARY

Therefore, it is a primary object of the present invention to provide a novel communication terminal, a storage medium storing a communication terminal controlling program, a communication terminal controlling method, a storage medium storing a communication controlling program, and authentication system.

Another object of the present invention is to provide a novel communication terminal, a storage medium storing a communication terminal controlling program, a communication terminal controlling method, a storage medium storing a communication controlling program, and an authentication system which are able to easily create an encrypted file which can be decrypted by only an opponent intended by the sender, and send the encrypted file to the opponent.

The present invention employs following features in order to solve the above-described problems. It should be noted that reference numerals inside the parentheses and supplemental remarks show one example of a corresponding relationship with the embodiments described later for easy understanding of the present invention, and do not limit the present invention.

A first invention is a communication terminal, comprises: a memory for storing common key information set with a communication terminal of an opponent and unique information of the opponent; a selector for selecting a file to be sent; a first encryption key creator for creating a first encryption key from the unique information of the opponent and the common key information; an encrypted file creator for creating an encrypted file from the file selected by the selector by utilizing the encryption key created by the first encryption key creator; and a sender for sending the encrypted file created by the encrypted file creator to the communication terminal of the opponent.

In the first invention, a memory (32) of a communication terminal (10) stores common key information (340) set with a communication terminal of an opponent and unique information (338b, 342) of the opponent. A selector (20, S3) selects a file to be sent. A first encryption key creator (20, S13) creates a first encryption key from the unique information from the opponent and the common key information. An encrypted file creator (20, S15) creates an encrypted file from the file selected by the selector by utilizing the encryption key created by the first encryption key creator. A sender (20, S21) sends the encrypted file created by the encrypted file creator to the communication terminal of the opponent.

For example, the unique information is e-mail address, Bluetooth (registered trademark) appliance information, etc. and the first encryption key is created from the e-mail address of the opponent to be sent and the common key information. Furthermore, the encrypted file is an attached file attached to e-mail and a file to be sent by a Bluetooth communication. Then, the file selected by the selector is encrypted by using the first encryption key in a common key encryption scheme, and then sent by the sender.

According to the first invention, the communication terminal which sends the encrypted file can send an encrypted file which cannot be decrypted without the unique information of the opponent to be sent which is decided by the sender. That is, it is possible to easily create an encrypted file which can be decrypted only by the opponent to whom the sender wants to send, and send the encrypted file to the opponent.

A second invention is according to the first invention, and further comprises an attacher for attaching the encrypted file created by the encrypted file creator to e-mail as an attached file, wherein the sender sends the e-mail to which the encrypted file is attached by the attacher to the communication terminal of the opponent.

In the second invention, an attacher (20, S17) attaches the encrypted file created by the encrypted file creator to mail (e-mail) as an attached file. Then, the sender sends the e-mail to which the encrypted file is attached by the attacher to the communication terminal of the opponent.

According to the second invention, the user can send the encrypted file to the opponent by attaching it to e-mail as an attached file.

A third invention is according to the second invention, and further comprises a historical mail storage for storing the e-mail attached with the encrypted file which is sent by the sender as a historical mail.

In the third invention, a historical mail storage (20, S25) stores the e-mail attached with the encrypted file which is sent by the sender as a historical mail. For example, the historical mail is an outgoing mail of the sent e-mail, and a historical mail storage stores the history of the outgoing mail.

According to the third invention, the sender of the e-mail can confirm the opponent who sends the file attached with the encrypted file by confirming the historical mail.

A fourth invention is according to the second invention, and further comprises a selected-file-temporary storage for temporarily storing the file selected by the selector; a selected-file attacher for attaching the selected file stored by the selected-file-temporary storage to the historical mail stored by the historical mail storage; and an encrypted file deleter for deleting the encrypted file of the historical mail stored in the historical mail storage.

In the fourth invention, a selected-file-temporary storage (20, S5) temporarily stores the file selected by the selector. A selected-file attacher (20, S29) attaches the selected file stored by the selected-file-temporary storage to the historical mail stored by the historical mail storage. An encrypted file deleter (20, S31) deletes the encrypted file of the historical mail stored in the historical mail storage.

That is, the selected-file attacher attaches the selected file before the encryption to the historical mail, and the encrypted file deleter deletes the encrypted file attached to the historical mail.

According to the fourth invention, the file attached to the historical mail is a file before encryption, and therefore, there is no need of decrypting the attached file when new e-mail is created by using the historical mail.

A fifth invention is according to the second invention, and the encryption key creator includes a second encryption key creator for, in a case of a plurality of opponents for sending, creating a second encryption key which can be decrypted with unique information of each of the opponents; and the sender broadcasts one e-mail attached with a encrypted file which is encrypted by using the second encryption key created by the second encryption key creator to the respective communication terminals of the opponents. In the fifth invention, a second encryption key creator (20, S53), in a case of a plurality of opponents for sending, creates a second encryption key which can be decrypted with unique information of each of the opponents. Then, the sender broadcasts one e-mail attached with a encrypted file which is encrypted by using the second encryption key created by the second encryption key creator to the respective communication terminals of the opponents. For example, in a case of three opponents to be sent, the second encryption key creator creates the second encryption key from the three unique information and the common key.

According to the fifth invention, in a case of a plurality of opponents for sending, the attached file is encrypted with the encryption key which can be decrypted in the respective communication terminals of the opponents, and therefore, it is only necessary to broadcast one e-mail to the respective opponents to be sent. Thus, in a case of a plurality of opponents to be sent, one encrypted file is only necessary to be created. In addition, the sender can confirm the sending history corresponding to the multi-address sending.

A sixth invention is according to the first invention, and the memory further stores unique information of its own machine, further comprises a receiver for receiving e-mail attached with the encrypted file sent from the communication terminal of the opponent; a decryption key creator for creating a decryption key from the unique information of its own machine and the common key information; and a decrypted file creator for creating a decrypted file from the encrypted file received by the receiver by using the decryption key created by the decryption key creator.

In the sixth invention, the memory further stores unique information (338a) of its own machine. A receiver (20, S73) receives e-mail attached with the encrypted file sent from the communication terminal of the opponent. A decryption key creator (20, S91) creates a decryption key from the unique information of its own machine and the common key information. A decrypted file creator (20, S93) creates a decrypted file from the encrypted file received by the receiver by using the decryption key created by the decryption key creator. That is, the decryption key creator creates a decryption key from the unique information of its own machine and the common key, and the decrypted file creator decrypts the encrypted attached file by using the decryption key. Thus, the encrypted attached file is decrypted by utilizing the unique information stored in the own communication terminal.

According to the sixth invention, the receiver who receives the encrypted attached file can decrypt the encrypted attached file without inputting a password for decryption.

A seventh invention is according to the sixth invention, and further comprises: a decrypted file temporary storage for temporarily storing the decrypted file decrypted by the decrypted file creator; a display for displaying the decrypted file temporarily stored by the decrypted file temporary storage; and a deleter for deleting the decrypted file temporarily stored by the temporary storage when an end of display by the display is detected.

In the seventh invention, a decrypted file temporary storage (20, S89) temporarily stores the decrypted file decrypted by the decrypted file creator. A display (20, 26, S97) displays the decrypted file temporarily stored by the decrypted file temporary storage. A decrypted file deleter (20, S105) deletes the decrypted file temporarily stored by the temporary storage when an end of display by the display is detected.

That is, the decrypted file is temporarily stored and then displayed by the display. After the completion of the display by the display, the decrypted file is deleted.

According to the seventh invention, if the confirmation of the content of the decrypted file by the receiver is ended, the decrypted file is deleted. This makes it possible to prevent transfer of the decrypted file and giving through copying by the receiver.

An eighth invention is according to the sixth invention, and the memory stores a first personal identification number, and further comprises a personal identification number requester for requesting a second personal identification number after the encrypted file is received by the receiver, wherein the decryption key creator creates a decryption key when the second personal identification number obtained by the personal identification number requester matches with the first personal identification number.

In the eighth invention, the memory stores a first personal identification number (338d). A personal identification number requester (20, S75, S79) requests a second personal identification number (lock No) after the encrypted file is received by the receiver. The decryption key creator creates a decryption key when the second personal identification number obtained by the personal identification number requester matches with the first personal identification number. For example, the personal identification number is used for determining whether a possessor of the communication terminal or not. Furthermore, the request of the second personal identification number is performed by the GUI displayed on the LCD monitor. That is, if an operation is performed by a possessor knowing the first personal identification number, the decryption key is created, with which the encrypted file is decrypted.

According to the eighth invention, it is possible to prevent an operation by a third party except for the possessor of the communication terminal, heightening the secrecy of the encrypted file.

A ninth invention is according to the sixth invention, and further comprises a storage for storing the e-mail attached with the encrypted file which is received by the receiver.

In the ninth invention, a storage (20, 346a, S81) stores the e-mail attached with the encrypted file which is received by the receiver. That is, the received attached file is also stored by the storage.

According to the ninth invention, the encrypted attached file is stored by the storage, and therefore, the receiver can confirm the content of the attached file whenever he or she wants.

A tenth invention is a storage medium storing a communication terminal controlling program which causes a processor (20) of a communication terminal (10) including a memory storing common key information (340) set with an opponent and unique information (338b, 342) of the opponent to function as a selector (S3) for selecting a file to be sent; an encryption key creator (S13) for creating a encryption key from the unique information of the opponent and the common key information; an encrypted file creator (S15) for creating an encrypted file from the file selected by the selector by utilizing the encryption key created by the encryption key creator; and a sender (S21) for sending the encrypted file created by the encrypted file creator to the communication terminal of the opponent.

In the tenth invention also, similar to the first invention, the sender can send the encrypted file which can be decrypted only by the opponent to whom the sender intends to send.

An eleventh invention is according to the tenth invention, and is a storage medium storing a communication terminal controlling program which causes a processor of the communication terminal further storing the unique information (338a) of its own machine in the memory to further function as a receiver (S73) for receiving an encrypted file sent from the communication terminal of the opponent; a decryption key creator (S91) for creating a decryption key from the unique information of its own machine and the common key information; and a decrypted file creator (S93) for creating a decrypted file from the encrypted file received by the receiver by utilizing the decryption key created by the decryption key creator.

In the eleventh invention also, similar to the sixth invention, the receiver who receives the encrypted attached file can decrypt the encrypted attached file without inputting a password, etc. for decryption.

A twelfth invention is a controlling method of a communication terminal (10) including a memory (32) storing common key information (340) set with a communication terminal of an opponent and unique information (338b, 342) of the opponent, and comprises the step of selecting a file to be sent (S3); creating a encryption key from the unique information of the opponent and the common key information (S13); creating an encrypted file from the file selected by the selecting step by utilizing an encryption key created by the encryption key creating step (S15); and sending e-mail to which the encrypted file is attached by the attaching step to the communication terminal of the opponent (S21).

In the twelfth invention also, similar to the first invention, the sender can send the encrypted file which can be decrypted only by the opponent to whom the sender intends to send.

A thirteenth invention is according to the twelfth invention, and is a controlling method of a communication terminal further storing unique information (338a) of its own machine in a memory, and further comprises the steps of receiving an encrypted file sent from the communication terminal of the opponent (S73); creating a decryption key from the unique information of its own machine and the common key information (S91); and creating a decrypted file from the encrypted file received by the receiving step by utilizing the decryption key created by the decryption key creating step (S93).

In the thirteenth invention, similar to the sixth invention, the receiver who receives the encrypted attached file can decrypt the encrypted attached file without inputting a password for decryption.

A fourteenth invention is a storage medium storing a communication controlling program which causes a processor of a PC including a memory storing common key information (340) set with a communication terminal of an opponent and unique information (338b, 342) of the opponent to function as a selector (S3) for selecting a file to be sent; an encryption key creator (S13) for creating a encryption key from the unique information of the opponent and the common key information; an encrypted file creator (S15) for creating an encrypted file from the file selected by the selector by utilizing the encryption key created by the encryption key creator; and a sender (S21) for sending the encrypted file created by the encrypted file creator to the communication terminal of the opponent.

In the fourteenth invention also, similar to the first invention, the sender can send the encrypted file which can be decrypted only by the opponent to whom the sender intends to send.

A fifteenth invention is an authentication system including a server managing reencryption processing of an encrypted file and a communication terminal according to any one of claims 6 to 9, a communication terminal comprises a change confirmer for confirming a change of the unique information of the own machine stored by the memory; an authentication information sender for sending authentication information for reencryption of the encrypted file when it is confirmed that the unique information of the own machine is changed by the change confirmer, and an encrypted file is stored by the storage; a list receiver for receiving a list of the unique information set to the own machine which is sent from the server in response to a request from the requrester; a decrypted-file-for-reencryption creator for creating a decrypted file for reencryption from the encrypted file stored in the storage on the basis of the list received by the list receiver; a reencryption key creator for creating a reencryption key by utilizing the changed unique information of the own machine stored in the memory and the common key information; and a reencrypted file creator for creating a reencrypted file from the decrypted file for reencryption created by the decrypted-file-for-reencryption creator by utilizing the reencryption key created by the reencryption key creator, and the server comprises a list sender for sending the list of the unique information set to the communication terminal when authentication information sent from the communication terminal is correct.

The fifteenth invention is an authentication system including a server (200) for managing reencryption processing of an encrypted file and a communication terminal (10) according to any one of claims 6 to 9. A change confirmer (20, S113) of the communication terminal confirms a change of the unique information of the own machine stored by the memory. An authentication information sender (12, 14, 20, S117) sends authentication information for reencryption of the encrypted file when it is confirmed that the unique information of the own machine is changed by the change confirmer, and an encrypted file is stored by the storage. A list receiver (12, 14, 20, S119) receives a list of the unique information set to the own machine which is sent from the server in response to the authentication information sender sending the authentication information. A decrypted-file-for-reencryption creator (20, S121) creates a decrypted file for reencryption from the encrypted file stored in the storage on the basis of the list received by the list receiver. A reencryption key creator (20, S123) creates a reencryption key by utilizing the changed unique information of the own machine stored in the memory and the common key information. A reencrypted file creator (20, S125) creates a reencrypted file from the decrypted file for encryption created by the decrypted-file-for-reencryption creator by utilizing the reencryption key created by the reencryption key creator. A list sender (204, S137) of the server sends the list of the unique information set to the communication terminal when authentication information sent from the communication terminal is correct.

That is, the decrypted-file-for-reencryption creator creates a decryption key from the unique information recorded in the list of the unique information set to the communication terminal and common key to thereby create a decrypted file for reencryption. Then, the reencrypted file creator creates an encryption key from the changed unique information and the common key, to thereby reencrypt the decrypted file for reencryption. That is, even if the unique information of the communication terminal storing the encrypted file is changed, by requesting a reencryption to the server, it is possible to reencrypt the encrypted file with the changed unique information.

According to the fifteenth invention, even if the unique information is changed, reencryption is made with the changed unique information to allow the encrypted file to be decrypted, improving the usefulness of the receiver.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a communication terminal of one embodiment of the present invention;

FIG. 2 is an illustrative view showing one example of a memory map of a RAM shown in FIG. 1;

FIG. 3 is an illustrative view showing a part of a data storage area stored in the RAM shown in FIG. 2;

FIG. 4 is a flowchart showing a part of e-mail sending processing of a CPU shown in FIG. 1;

FIG. 5 is a flowchart showing another part of the e-mail sending processing of the CPU shown in FIG. 1 and a sequel to FIG. 4;

FIG. 6 is a flowchart showing key creating processing of the CPU shown in FIG. 1;

FIG. 7 is a flowchart showing a part of e-mail receiving processing of the CPU shown in FIG. 1;

FIG. 8 is a flowchart showing another part of the e-mail receiving processing of the CPU shown in FIG. 1, and sequel to FIG. 7;

FIG. 9 is an illustrative view showing a GUI to be displayed on an LCD monitor shown in FIG. 1;

FIG. 10 is an illustrative view showing sending of an encrypted file according to the first embodiment;

FIG. 11 is an illustrative view showing another sending of an encrypted file according to the first embodiment;

FIG. 12 is a flowchart showing address changing processing of the CPU shown in FIG. 1;

FIG. 13 is a flowchart showing authentication processing of a CPU of an authentication server;

FIG. 14 is a sequence diagram showing communication processing applied to a second embodiment; and

FIG. 15 is a sequence diagram showing communication processing applied to a third embodiment.

### DETAILED DESCRIPTION

### First Embodiment

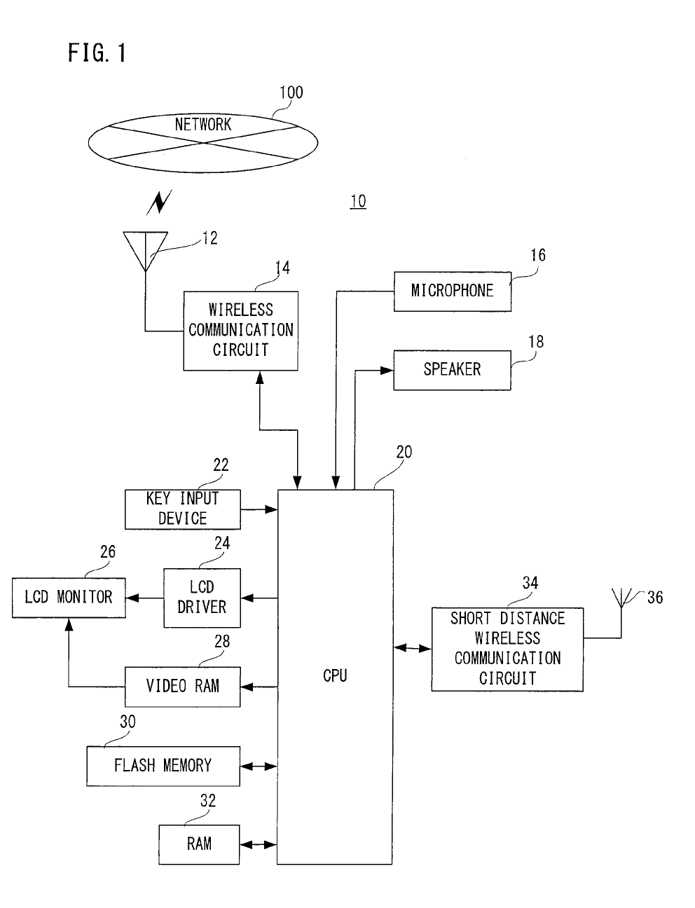

Referring to FIG. 1, a communication terminal 10 includes a key input device 22. When a call-out operation is performed by the key input device 22, a CPU (may be called a processor or a computer) 20 outputs a call-out signal by controlling a wireless communication circuit 14. The output call-out signal is output from an antenna 12 and sent to a mobile communication network including base stations. When an intended party or an opponent performs an answer operation, a state that a telephone communication can be made is established.

When a conversation end operation is performed by the key input device 22 after shift to the state that a telephone communication can be made, the CPU 20 sends an on-hook signal to the intended party by controlling the wireless communication circuit 14. After sending the on-hook signal, the CPU 20 ends the conversation processing. In a case that an on-hook signal is first received from the intended party, the CPU 20 ends the conversation processing. Furthermore, in a case that an on-hook signal is received not from the intended party but from the mobile communication network as well, the CPU 20 ends the conversation processing.

When a call-out signal from the intended party is received by the antenna 12 in a state that the communication terminal 10 is powered-on, the wireless communication circuit 14 notifies an incoming call to the CPU 20. The CPU 20 displays on an LCD monitor 26 calling source information described in the incoming call notification by controlling the LCD monitor 26 by an LCD driver 24 and storing an image required for drawing in a video RAM 28. Furthermore, the CPU 20 outputs an incoming call tone from an incoming call notifying speaker not shown.

In the state that a telephone communication can be made, following processing is executed. A modulated audio signal (high frequency signal) sent from the intended party or the opponent is received by the antenna 12. The modulated audio signal to be received is subjected to demodulation processing and decryption processing by the wireless communication circuit 14. The received voice signal thus obtained is output from the speaker 18. A voice signal to be sent which is taken by the microphone 16 is subjected to encryption processing and modulation processing by the wireless communication circuit 14. The modulated audio signal thus generated is sent to the intended party by means of the antenna 12 as described above.

In addition, when a data communication operation is performed with the network 100 by the key input device 22, the CPU 20 starts to communicate with the network 100 through the antenna 12 and the wireless communication circuit 14. The network 100 is connected with a plurality of network servers not shown, and the CPU 20 performs data communication with each of the plurality of network servers via the network 100. The LCD monitor 26 displays images and character strings which are obtained by the data communication. Furthermore, the communication terminal 10 has an e-mail (electronic mail) function, and can receive and send e-mail via the network 100. Additionally, in a case that e-mail is received, the wireless communication circuit 14 notifies reception of the e-mail to the CPU 20 similar to the case of the incoming calling. The CPU 20 displays on the LCD monitor 26 mail source information from header information, etc. of the e-mail.

The communication terminal 10 further includes a short distance wireless communication circuit 34 according to a Bluetooth standard, and the short distance wireless communication circuit 34 makes a short distance radio communication with other appliances compatible with the Bluetooth system through an antenna 36. This makes it possible to send an image file and a character string file which stored in a flash memory 30 or a RAM 32 to another communication terminal 10, or receive an image file and a character string file from another communication terminal 10 and store the same in the flash memory 30 or the RAM 32.

In the e-mail function of the communication terminal 10 here, an image file and a character string file can be attached to e-mail as an attached file. Furthermore, a sub-function of the e-mail function includes a secret sending function of the attached file. The secret sending function of the attached file is a function of encrypting the attached file to thereby send the encrypted file which is decryptable only by a opponent to be sent (receiver) of the e-mail.

Hereinafter, encrypting an attached file and sending the same is called “secret sending”, and sending an attached file without encryption is called “normal sending”.

More specifically, file encryption /decryption software is set up in the communication terminal 10 of the sender and the communication terminal 10 of the opponent to be sent. The file encryption /decryption software adopts a common key encryption scheme in which a key used for encryption and a key used for decryption are the same, and the algorithm of the common key encryption scheme adopts “K2”, and the length of the common key is 128 bits. Furthermore, a common key is set between the communication terminal 10 of the sender and the communication terminal 10 of the opponent to be sent or the other party. It should be noted that as an algorithm of the common key encryption scheme, “AES (Advanced Encryption Standard)”, “DES (Data Encryption Standard)”, etc. may be applied.

When an attached file is encrypted, an encryption key is created from a common key and an e-mail address being unique information of the other party (receiver) to thereby encrypt the selected file as an attached file. Then, the communication terminal 10 of the sender attaches the encrypted file to the e-mail as an attached file, and sends the same to the other party.

When receiving the e-mail attached with the encrypted file, the communication terminal of the receiver (the other party) creates a decryption key from the common key and the e-mail address set to its own communication terminal. The e-mail address used for creating the decryption key is the e-mail address the same as that used when the encryption key is created. Thus, in the communication terminal 10 of the receiver, the received encrypted file can be decrypted by the created decryption key, so that the receiver can confirm the content of the encrypted file. Furthermore, in the communication terminal 10 of the receiver, the decrypted file is stored in a buffer, and only the encrypted file is saved. The data saved in the buffer is a temporarily stored state, and cannot be operated by the receiver. This makes it possible to prevent the decrypted file form being transferred.

In addition, even if the encrypted file is transferred to a third party by the receiver, and the common key used for creating the decryption key is the same, the communication terminal 10 of the third party has a different e-mail address, and thus, it is impossible to decrypt the encrypted file. Moreover, even if the sent e-mail is intercepted by a PC, etc. and the attached file is obtained and the e-mail address is known, it is impossible to decrypt the e-mail due to the lack of the common key.

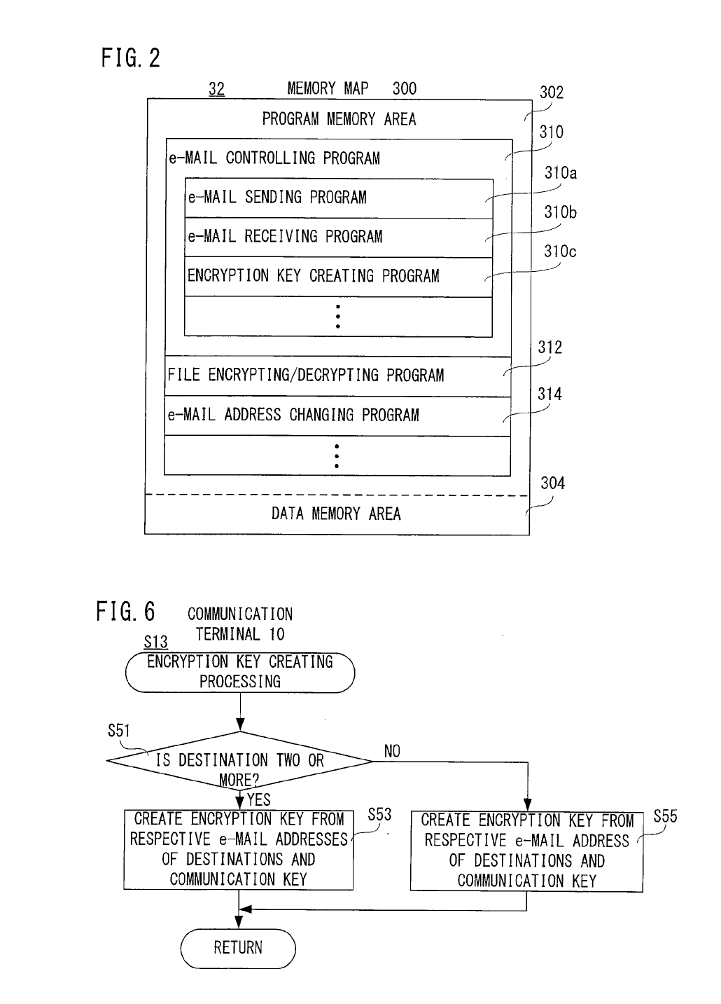

FIG. 2 is an illustrative view showing a memory map of the RAM 32. Referring to FIG. 2, a memory map 300 of the RAM 32 includes a program memory area 302 and a data memory area 304. A part of the programs and data are read from the flash memory 30 entirely at a time, or partially and sequentially as necessary so as to be stored into the RAM 32 and processed by the CPU 20.

The program memory area 302 stores programs for operating the communication terminal 10. The program for operating the communication terminal 10 is constituted of an e-mail controlling program 310, a file encrypting/decrypting program 312, an e-mail address changing program 314, etc. Here, the e-mail controlling program 310 includes an e-mail sending program 310a, an e-mail receiving program 310b, an encryption key creating program 310c, etc.

The e-mail controlling program 310 is a program for controlling encryption processing of an attached file when e-mail is sent, and controlling decryption processing after e-mail attached with the encrypted file is received. Here, the e-mail sending program 310a is a program for creating an encryption key from the e-mail address of the opponent to be sent or the other party and the common key when the file attached to the created e-mail is encrypted, encrypting the attached file with the encryption key, and then sending the same. The e-mail receiving program 310b is a program for creating a decryption key from the e-mail address set to the communication terminal 10 of the receiver and the common key when e-mail attached with an encrypted file is received, and decrypting the encrypted file with the decryption key. Moreover, the encryption key creating program 310c is a program for switching an encryption key to be created depending on the number of opponents to be sent when an encryption key is created.

The file encrypting/decrypting program 312 is a program for encrypting and decrypting a file, and by execution of this program, it is possible to perform encryption processing of an attached file and decryption processing of the received encrypted file. The e-mail address changing program 314 is a program for changing the e-mail address set to the communication terminal 10 and reencrypting the encrypted file with the new e-mail address.

Although illustration is omitted, the program for operating the communication terminal 10 includes a communication controlling program, current time notifying program, etc.

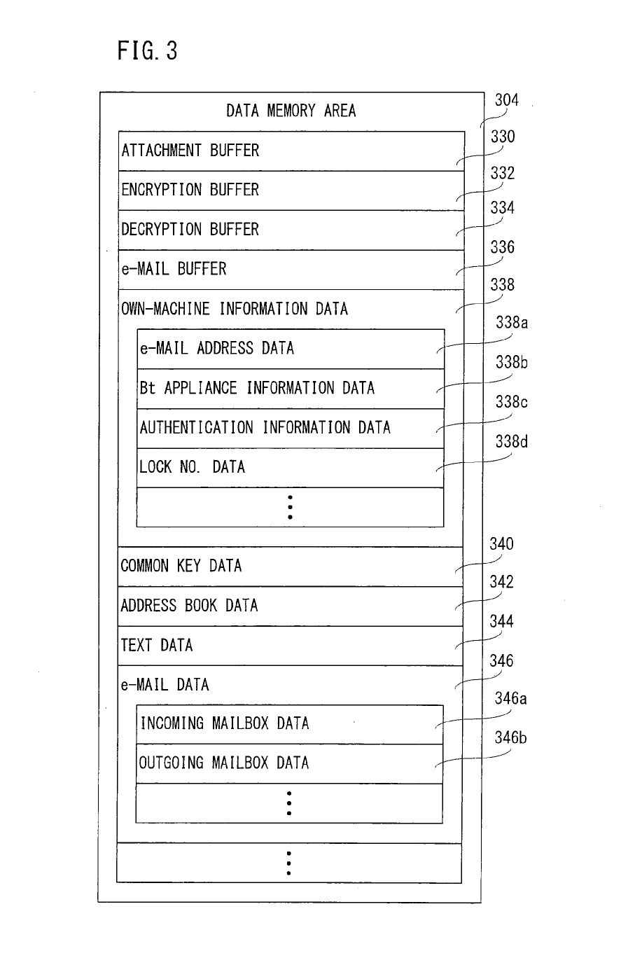

As shown in FIG. 3, the data memory area 304 is provided with an attachment buffer 330, an encryption buffer 332, a decryption buffer 334 and an e-mail buffer 336. Furthermore, the data memory area 304 stores own-machine information data 338, common key data 340, address book data 342, text data 344 and e-mail data 346. Here, the own-machine information data 338 includes e-mail address data 338a, Bt (Bluetooth) appliance information data 338b, authentication information data 338c, a lock No. (lock Number) data 338d, etc., and the e-mail data 346 includes incoming mailbox data 346a and outgoing mailbox data 346b.

The attachment buffer 330 is a buffer for attaching a file to e-mail, and temporarily storing the selected file. The encryption buffer 332 is a buffer for encrypting a selected file selected for attachment, and temporarily storing the selected file or encrypted file. The decryption buffer 334 is a buffer for decrypting a received encrypted file, and temporarily storing an encrypted file or a decrypted file. The e-mail buffer 336 is a buffer for creating e-mail, and temporarily storing data of e-mail during creation.

The own-machine information data 338 is made up of a plurality of unique information set to the communication terminal 10. For example, the e-mail address data 338a is data of the e-mail address corresponding to the communication terminal 10. The Bt appliance information data 338b is used for specifying a communication partner when a short distance radio communication according to the Bluetooth system is performed, and unique information to be set to the communication terminal 10.

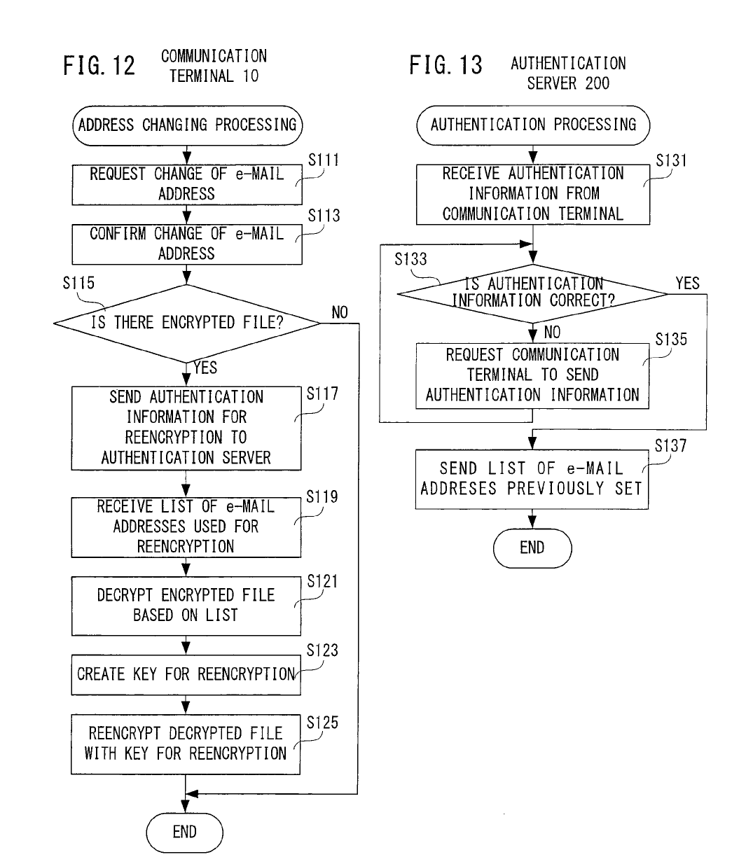

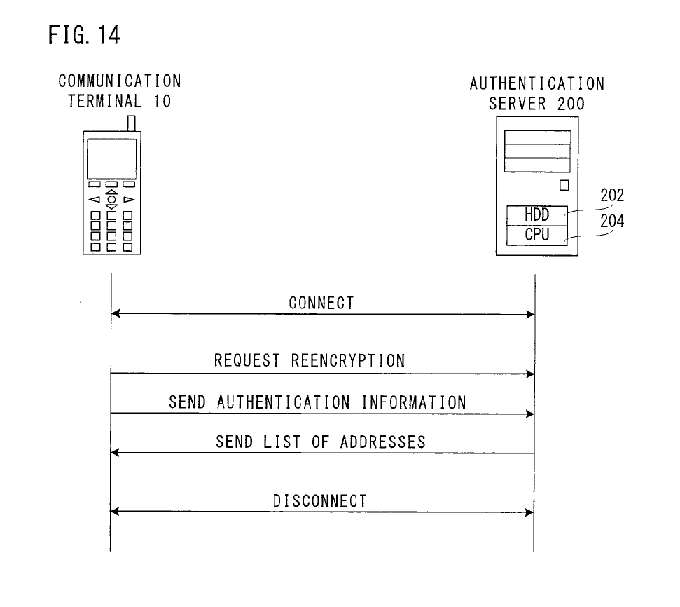

The authentication information data 338c is data necessary for authentication processing when data communication with an authentication server 200 (see FIG. 14), etc., is made and used for authentication of reencryption of the encrypted file (described later in FIG. 12 and FIG. 13) in this embodiment. The lock No. data 338d is data used for verifying that a user, such as a sender or a receiver, is an authorized possessor of the communication terminal 10, and is a personal identification number, etc. For example, in this embodiment, if a lock No. the user inputs and the lock No data 338d are coincident with each other, it is determined that the user is an authorized possessor. Noted that although illustration is omitted, the own-machine information data 338 includes phone number data, etc.

The common key data 340 is data to be used at a time of encrypting or decrypting. The content of the common key data 340 cannot be referred even by the user of the communication terminal 10, and is information known only by the creator of the file encryption/decryption software and has high secrecy. Here, in this embodiment, one common key data 340 is used, but a plurality of common key data 340 may be used. In a case that a plurality of common key data 340 are used, each of the common key data 340 is identified by meta-information, and the meta-information of the common key used for the encryption is added to the header information of the e-mail attached with the encrypted file or the header information of the encrypted file. That is, the communication terminal 10 which has received the encrypted file can specify the common key to be used for decryption with reference to the header information of the e-mail or the header information of the encrypted file.

The address book data 342 is data being constituted of e-mail addresses of the opponents to whom e-mails are sent and telephone numbers of the opponents to whom a phone call is placed. For example, the sender can determine a destination of the e-mail with reference to the content of the address book data 342. The text data 344 is data storing sentences obtained through data communications with the server or sentences created by the communication terminal 10 in a text format. For example, the text data 344 is constituted of data storing in a text format a “list of names.txt” of a cooperation to which the sender belongs.

The e-mail data 346 includes data of sent e-mails (hereinafter referred as an outgoing mail) and received e-mails (hereinafter referred as an incoming mail). For example, the incoming mailbox data 346a is constituted of data of an incoming mail and data of an attached file attached to the incoming mail. The outgoing mailbox data 346b is constituted of data of an outgoing mail and an attached file attached to the outgoing mail. The outgoing mail included in the outgoing mailbox data 346b may be called a historical mail for representing a history of e-mails.

Although illustration is omitted, the data memory area 304 stores image files, and is provided with other counters and flags which are required for an operation of the communication terminal 10.

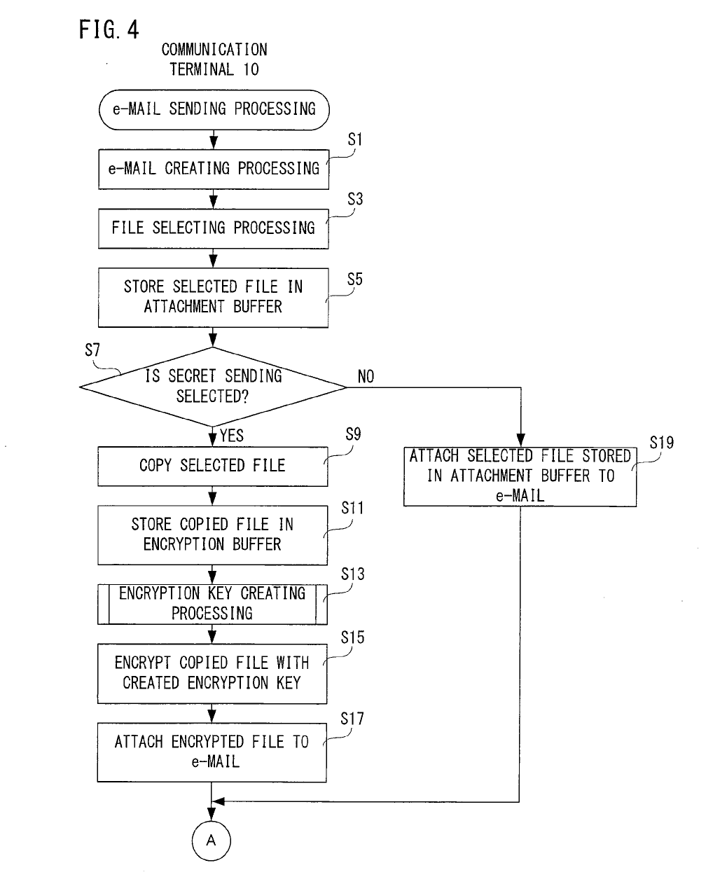

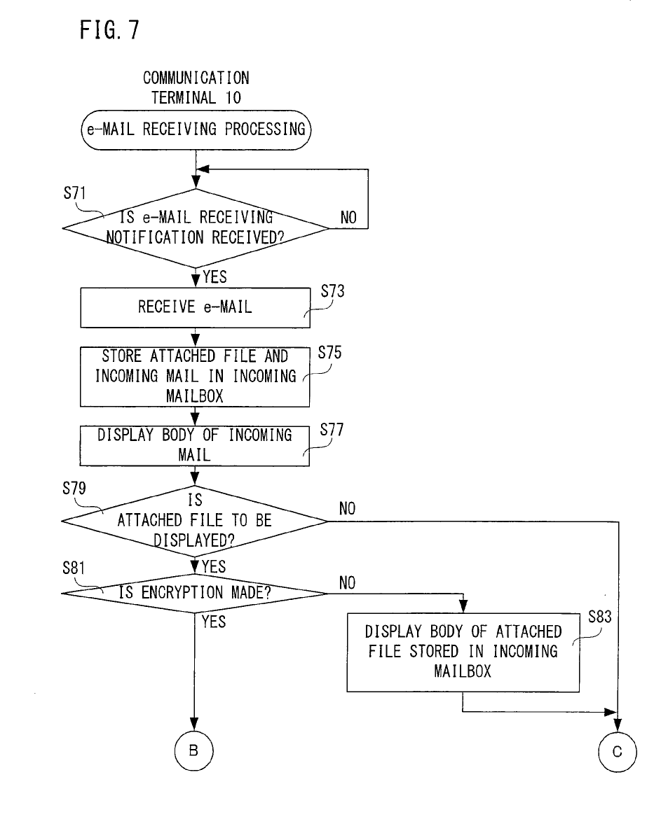

The CPU 20 performs in parallel a plurality of tasks including e-mail sending processing shown in FIG. 4, 5, encryption key creating processing shown in FIG. 6, and e-mail receiving process shown in FIG. 7, 8 under the control of a RTOS (Real-time Operating System) such as “Linux” and “REX”, etc.

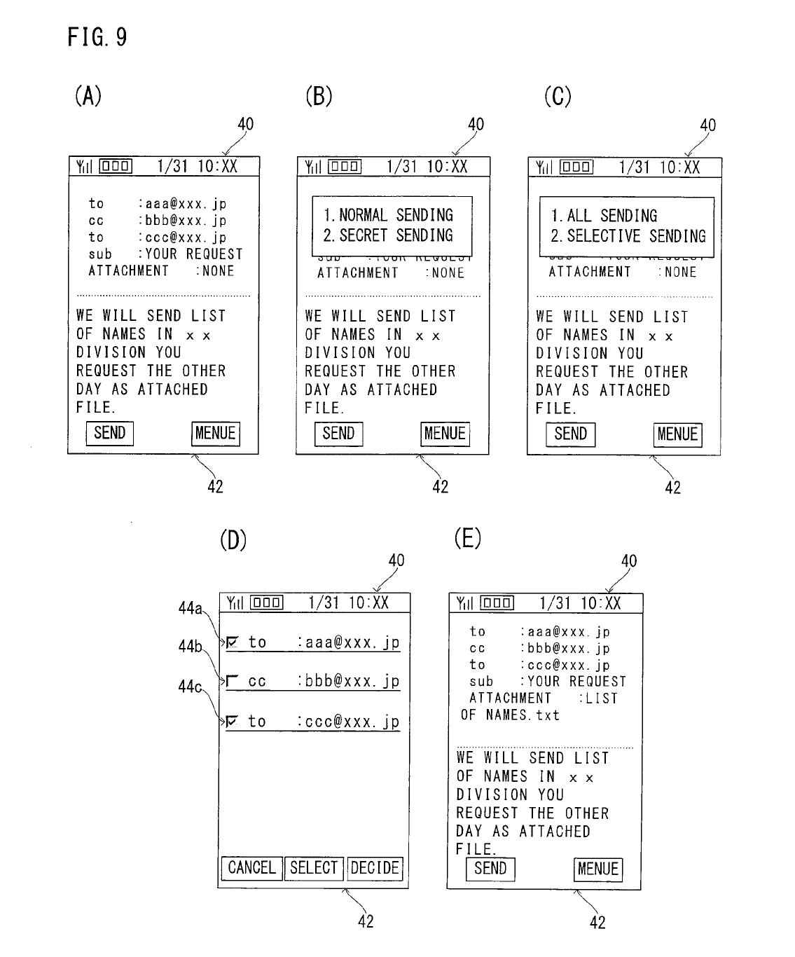

For example, when the sender operates the key input device 22 of the communication terminal 10 to create e-mail, the CPU 20 starts the e-mail sending processing as shown in FIG. 4, and executes e-mail creating processing in a step Si. For example, an e-mail creating screen shown in FIG. 9(A) is displayed on the LCD monitor 26. Furthermore, the data of the e-mail during creation is stored in the e-mail buffer 336. Referring to FIG. 9(A), the LCD monitor 26 is made up of a status display area 40 for displaying a display representing an incoming signal strength and a battery level of the communication terminal 10 and hour, and a function display area 42 for displaying a function during execution. Furthermore, in a case that the e-mail creating processing is executed, a body of the e-mail created by the sender, an e-mail address of the destination and a send button, and a menu button corresponding to the key input device 22 are displayed at the function display area 42. When the send button is operated, sending processing of the e-mail displayed on the LCD monitor 26 is performed. Furthermore, when the menu button is operated, GUI for selecting a sub-function of the e-mail function is displayed.

Here, with respect to the status display area 40 and the function display area 42, the same is true for other illustrative views, and therefore, in the other illustrative views, a detailed explanation is omitted for simplicity.

Returning to FIG. 4, in a next step S3, file selecting processing is executed. That is, processing of selecting a file to be attached to the created e-mail is executed. Here, text data 344 is selected as a selection file. Succeedingly, in a step S5, the selected file is stored in the attachment buffer 330. That is, the text data 344 is stored in the attachment buffer 330 as a selected file. It should be noted that since data obtained by copying the text data 344 is stored in the attachment buffer 330, the memory address of the text data 344 is not changed.

Then, in a step S7, it is determined whether or not a secret sending is selected. For example, in the step S7, the GUI shown in FIG. 9(B) is displayed on the LCD monitor 26 to determine whether the sender selects the “normal sending” or the “secret sending”. Here, when the file selecting processing (step S5) is ended in this embodiment, the GUI shown in FIG. 9(B) is displayed. If “NO” in the step S7, that is if the “normal sending” is selected, the selected file stored in the attachment buffer 330 is attached to the e-mail in a step S19, and the process proceeds to a step S21. That is, the selected file stored in the attachment buffer 330 is attached to the e-mail during creation as an attached file.

On the other hand, if “YES” in the step S7, that is, if the “secret sending” is selected, the process proceeds to a step S9 to copy the selected file. That is, the selected file stored in the attachment buffer 330 is copied. Succeedingly, in a step S11, the selected file copied in the step S9 is stored in the encryption buffer 332. That is, data the same as the text data 344 is further stored in the encryption buffer 332. Then, in a step S13, encryption key creating processing is executed. That is, an encryption key for encrypting the attached file is created from the data of the e-mail address of the opponent to be sent and the common key data 340. Furthermore, the encryption key creating processing is described later by utilizing the flowchart of the encryption key creating processing shown in FIG. 6. Here, the data of the e-mail address of the opponent to be sent is read from the e-mail creating buffer not shown for temporarily storing e-mail during creation.

Next, in a step S15, the copied file is encrypted with the created encryption key. That is, in the step S15, the copied selected-file stored in the encryption buffer 332 is encrypted with the encryption key created in the step S13. Here, the file which is encrypted is referred to as an encrypted file. Succeedingly, the encrypted file is attached to the e-mail in a step S17, and then, the process proceeds to the step S21. That is, in the step S17, the encrypted file stored in the encryption buffer 332 is attached to the e-mail during creation as an attached file. More specifically, the encrypted file stored in the encryption buffer 332 is incorporated in the data of the e-mail during creation stored in the e-mail buffer 336. Furthermore, information indicating that the attached file is encrypted is added to the header information of the attached file. In addition, on the LCD monitor 26, a display indicating that an attached file is attached to the e-mail is made as shown in FIG. 9(E).

By the processing in the steps S5-S17, the copied data of the text data 332 is encrypted, and attached to the e-mail during creation as an attached file.

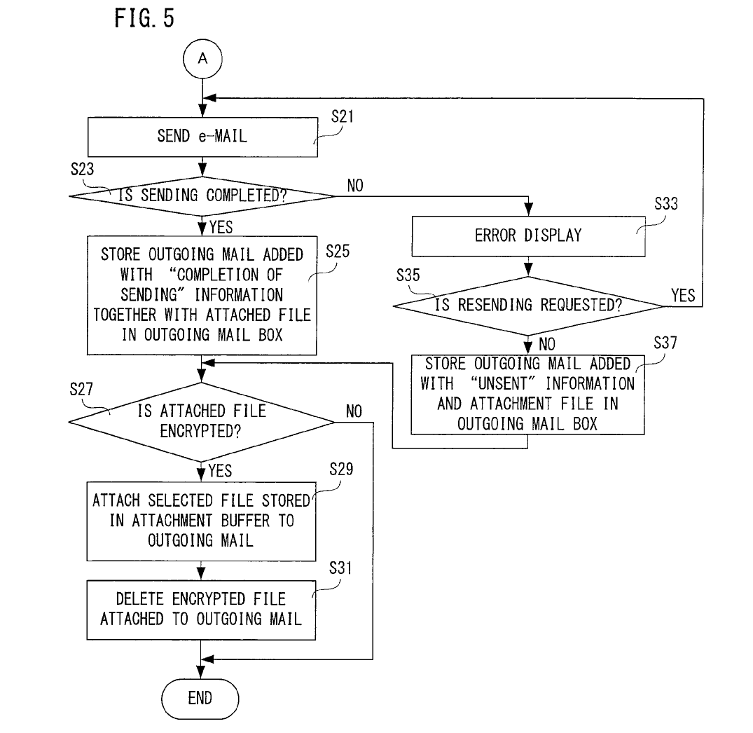

In the step S21 shown in FIG. 5, the e-mail is sent. That is, when the send button shown in FIG. 9(E) is operated, the data of the e-mail stored in the e-mail buffer 336 is sent to the opponent to be sent or the other party. Specifically, the data of the e-mail is sent to the mail server not shown connected to the network 100, and further sent to the communication terminal 10 corresponding to the e-mail address of the other party from the mail server.

Then, in a step S23, it is determined whether or not sending is completed. That is, in the step S23, it is determined whether or not the data of the e-mail is sent to the mail server not shown. If “NO” in the step S23, that is, if sending the e-mail is not completed, the process proceeds to a step S33. In this embodiment, if sending the e-mail is not completed after a lapse of preset time (60 seconds, for example) from the sending processing of the e-mail, “NO” may be determined in the step S23, or if a connection status (incoming signal strength) with the network 100 is bad, “NO” may be determined even if the preset time has not elapsed.

Alternatively, if “YES” in the step S23, that is, if the data of the e-mail can be sent, outgoing mail added with “completion of the sending” and the attached file are stored in the outgoing mailbox in a step S25. That is, the data of the e-mail stored in the e-mail buffer 336 is added with information meaning the “end of sending” in the header information, and stored as data making up of the outgoing mailbox data 346b together with the attached file. Thus, the sender can confirm the history of the sending by the LCD monitor 26 displaying the content of the outgoing mailbox data 364b, and moreover identify the other party who sends the encrypted file.

Next, in a step S27, it is determined whether or not the attached file is encrypted. That is, it is determined whether or not an encrypted file is stored in the encryption buffer 332. By providing an encryption flag in the RAM 32 being turned on when the attached file is encrypted (1), and being turned off (0) when the attached file is not encrypted, whether or not the attached file is encrypted may be determined.

If “NO” in the step S27, that is, if an encrypted file is not stored in the encryption buffer 332, the attachment buffer 330, the encryption buffer 332 and the e-mail buffer 336 are initialized to end the e-mail sending processing. On the other hand, if “YES” in the step S27, that is, if an encrypted file is stored in the encryption buffer 332, the selected file stored in the attachment buffer 330 is attached to the outgoing mail in a step S29. That is, the selected file stored in the attachment buffer 330 is attached to the latest outgoing mail included in the outgoing mailbox data 346b.

Succeedingly, in a step S31, the encrypted file attached to the outgoing mail is deleted. That is, in the step S31, the encrypted file attached to the latest outgoing mail is deleted. By the processing in the steps S29-S31, the encrypted file attached to the sent e-mail is replaced with the file before the encryption. This makes it possible to utilize the attached file even if new-e-mail is created by using the outgoing mail. That is, there is no need of decrypting the encrypted attached file.

In a step S33, if sending the e-mail has not been completed, an error display is performed. For example, a character string “the e-mail was not sent” is displayed on the LCD monitor 26. Succeedingly, in a step S35, it is determined whether or not resending is requested. It is determined whether or not a resending instruction of the e-mail is performed by the sender after the process in the step S33, for example. If “YES” in the step S35, that is, if an e-mail resending instruction is performed, the process returns to the step S21. On the other hand, if “NO” in the step S35, that is, if a e-mail resending instruction is not performed, the outgoing mail to which “unsent” information is added and the attached file are stored in the outgoing mailbox in a step S37, and the process proceeds to a step S27. That is, data of the e-mail stored in the e-mail buffer 336 to which information indicating “unsent” is added in the header information is stored as data making up of the outgoing mailbox data 346b together with attached file.

FIG. 6 is a flowchart showing the encryption key creating processing shown in the step S13 (see FIG. 4). The CPU 20 determines whether two or more destinations or not in a step S51. That is, it is determined whether or not two or more persons are set to the data of the e-mail during creation as destinations of an opponent to be sent. If “YES” in the step S51, that is, if two ore more persons are set as destinations of the opponent to be sent, an encryption key is created from the respective e-mail addresses of the destinations and the common key in a step S53, and the process returns to the e-mail sending processing.

For example, in a case that one e-mail attached with an encrypted file is broadcasted to opponents to be sent A, B, C, an encryption key K is created from the data of the e-mail addresses of the respective opponents and the common key data 340. Additionally, an encrypted file F encrypted with this encryption key K can be decrypted in each of the communication terminals 10 of the opponents to be sent. That is, the encrypted file F can be decrypted by using any of a decryption key AK created from the e-mail address of the opponent to be sent A and the common key data 340, a decryption key BK created from the e-mail address of the opponent to be sent B and the common key data 340 and a decryption key CK created from the e-mail address of the opponent to be sent C and common key data 340. Thus, in a case of a plurality of opponents to be sent, one encrypted file is only necessary to be created. In addition, the sender can confirm a sending history corresponding to the multi-address sending.

Furthermore, in a case of a plurality of opponents to be sent, the sender can decide in advance the opponents who can perform decryption. For example, if there are three opponents, when the “secret sending” is selected in FIG. 9(B), the GUI shown in FIG. 9(C) is displayed. That is, the sender can select “all sending” which makes decryptable in the communication terminals 10 of all the three opponents or “selective sending” which makes decryptable in the communication terminals 10 of two or more opponents out of the three opponents. Here, if the “selective sending” is selected, the GUI shown in FIG. 9(D) is displayed. Referring to FIG. 9(D), check boxes 44a, 44b and 44c (hereinafter referred to as a check box 44 in a case that the respective check boxes are not identified.) respectively correspond to e-mail addresses “aaa@xxx.jp”, “bbb@xxx.jp” and “ccc@xxx.jp”. Furthermore, when a check is set in the check box 44, a corresponding e-mail address is set as e-mail for which an encryption key is created.

In addition, the cancel button, the selection button and the decision button displayed at the lower part of the function display area 42 correspond to the key input device 22, and are arbitrarily operated by the sender. When the cancel button is operated, the sender can cancel the check within one check box 44. When the selection button is operated, the sender can set a check within the one check box 44. When the decision button is operated, an encryption key is created from the e-mail address corresponding to the checked check box 44 and a common key, and an attached file is encrypted by the encryption key.

For example, in FIG. 9(D), the check boxes 44a, 44c are checked, and therefore, when the decision button is operated, an encryption key is created from the e-mail addresses “aaa@xxx.jp” and “ccc@xxx.jp” and the common key data 340, and the attached file is encrypted therewith. Furthermore, the fact that a “list of names.txt” is set as an attached file is displayed on the LCD monitor 26 as shown in FIG. 9(E).

Here, when the “normal sending” is selected in FIG. 9(B), or when the “all sending” is selected in FIG. 9(C), the display shown in FIG. 9(E) is made on the LCD monitor 26. In addition, in a case of one opponent to be sent, even if the “secret sending” is selected in FIG. 9(B), the display shown in FIG. 9(E) is displayed on the LCD monitor 26.

Furthermore, if “NO” in the step S51, that is, in a case that the address of the opponent to be sent is one, an encryption key is created by utilizing the e-mail address of the destination and the common key in a step S55, and the process returns to the e-mail sending processing. That is, since there is no need of specifying decryptable opponents, it is possible to create the encryption key from the data of the e-mail address of the opponent and the common key data 340.

As shown in FIG. 7, when executing the e-mail receiving process, the CPU 20 determines whether or not an e-mail receiving notification is received in a step S71. That is, it is determined whether or not an e-mail receiving notification sent from the mail server is received. Furthermore, in a case that the mail server receives e-mail, it sends the e-mail receiving notification to the communication terminal 10 corresponding to the destination (e-mail address) of the e-mail.

If “NO” in the step S71, that is, if an e-mail receiving notification is not received, the process in the step S71 is repeated. On the other hand, if “YES” in the step S71, e-mail is received in a step S73. That is, the e-mail is received through the data communication with the mail server. Succeedingly, in a step S75, the attached file and the incoming mail are stored in the incoming mailbox. That is, the incoming mail received from the mail server is stored as data making up of the incoming mailbox data 346a together with the attached file.

Next, in a step S77, the body of the incoming mail is displayed. That is, in the latest incoming mail included in the incoming mailbox data 346a, the character string data of the body is read to display the same on the LCD monitor 26. Furthermore, by reading the header information together with the character string data, the title of the incoming mail, the e-mail address of the sender, etc. may be displayed.

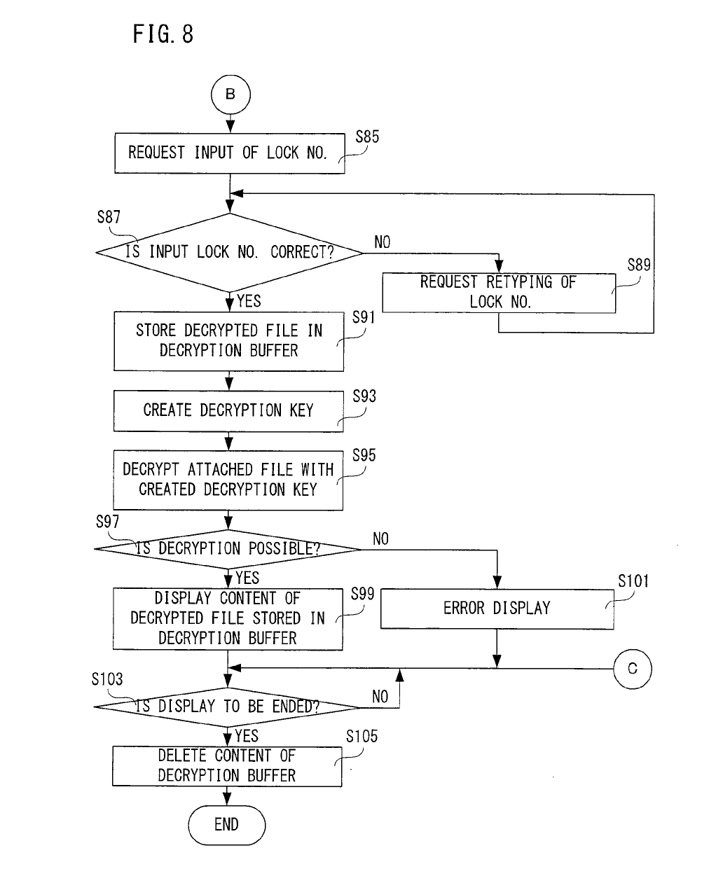

Next, in a step S79, it is determined whether or not the attached file is to be displayed. For example, the character string of “the attached file is to be opened?” is displayed on the LCD monitor 26, and then, the GUI for prompting the receiver to input whether or not to display the body of the attached file is displayed. If “NO” in the step S79, that is, if an instruction of not displaying the body of the attached file is provided, the process proceeds to a step Si 03 shown in FIG. 8. On the other hand, if “YES” in the step S79, that is, if an instruction of displaying the body of the attached file is provided, whether or not encryption is made in a step S81. That is, it is determined whether or not information indicating that the attached file is encrypted is added to the header information of the attached file. If “NO” in the step S81, that is, if the information indicating that the attached file is encrypted is not added, the body of the attached file stored in the incoming mailbox is displayed in a step S83, and the process proceeds to the step S103. That is, the content of the attached file attached to the latest incoming mail out of the incoming mail data making up of the incoming mailbox data 346a is displayed on the LCD monitor 26.

Additionally, if “YES” in the step S81, that is, if the information indicating that the attached file is encrypted is added, inputting a lock No. of the terminal is requested in a step S85 shown in FIG. 8. For example, a GUI for prompting the user to input the lock No. is displayed on the LCD monitor 26, to make the receiver input the lock No. This makes it possible to prevent a third party except for the possessor of the communication terminal 10 from operating the terminal, heightening the secrecy of the encrypted file.

Succeedingly, in a step S87, it is determined whether or not the input lock No. is correct. That is, it is determined whether or not the data of the input lock No. and the lock No. data 338 are coincident with each other. If “NO” in the step S87, that is, if the data of the input lock No. and the lock No. data 338 are not coincident, retyping the lock No. is requested in a step S89, and then the process returns to the step S87. For example, in the step S89, a GUI for prompting the user to retype the lock No. is displayed on the LCD monitor 26.

If “YES” in the step S87, that is, if the data of the input lock No. and the lock No. data 338 are coincident with each other, the attached file is stored in the decryption buffer 334 in a step S91. That is, the attached file attached to the latest incoming mail out of the incoming mail data making up of the incoming mailbox data 346a is copied and stored in the decryption buffer 334.

Then, in a step S93, a decryption key is crated. That is, a decryption key is created from the e-mail address data 366a and the common key data 388. More specifically, a decryption key is created from its own e-mail address and the common key the same as that of the communication terminal 10 of the sender. Succeedingly, in a step S95, the attached file is decrypted by the created decryption key. That is, the attached file stored in the decryption buffer 334 is decrypted with the created decryption key in the step S93.

Succeedingly, in a step S97, it is determined whether or not the decryption is successful. For example, the result of the decryption processing is indicated by an error flag not shown, and by the error flag, it is determined whether or not the decryption is successful. If “NO” in the step S97, that is, if the decryption processing fails, an error display is performed in a step S101, and the process proceeds to the step S103. In addition, as an error display, a character string saying that “the decryption is impossible” is displayed on the LCD monitor 26.

Furthermore, if “YES” in the step S97, that is, if the decryption processing is successful, the content of the decrypted file stored in the decryption buffer 334 is displayed in a step S99. For example, if the decrypted file obtained by decrypting the encrypted attached file is a text file, the content of the text file is displayed on the LCD monitor 26.

Next, in the step S103, it is determined whether or not the display is to be ended. It is determined whether or not an operation of ending the e-mail receiving process is performed with the key input device 22. Here, this may be processing of ending the display of the decrypted file. If “NO” in the step Si 03, that is, if an operation of ending the display of the decrypted file is not performed, the process in the step S103 is repeatedly executed. On the other hand, if “YES” in the step S103, that is, if an operation of ending the display of the decrypted file is performed, the content of the decryption buffer 334 is deleted in a step S105. That is, the decrypted file is deleted. That is, even if the attached file is decrypted, the decrypted file is not stored in the RAM 32. This makes it possible to prevent the receiver from transferring the decrypted file and giving the copied one. Furthermore, since the received encrypted file is stored according the processing in the step S81, the receiver can confirm the content of the attached file whenever he or she wants.

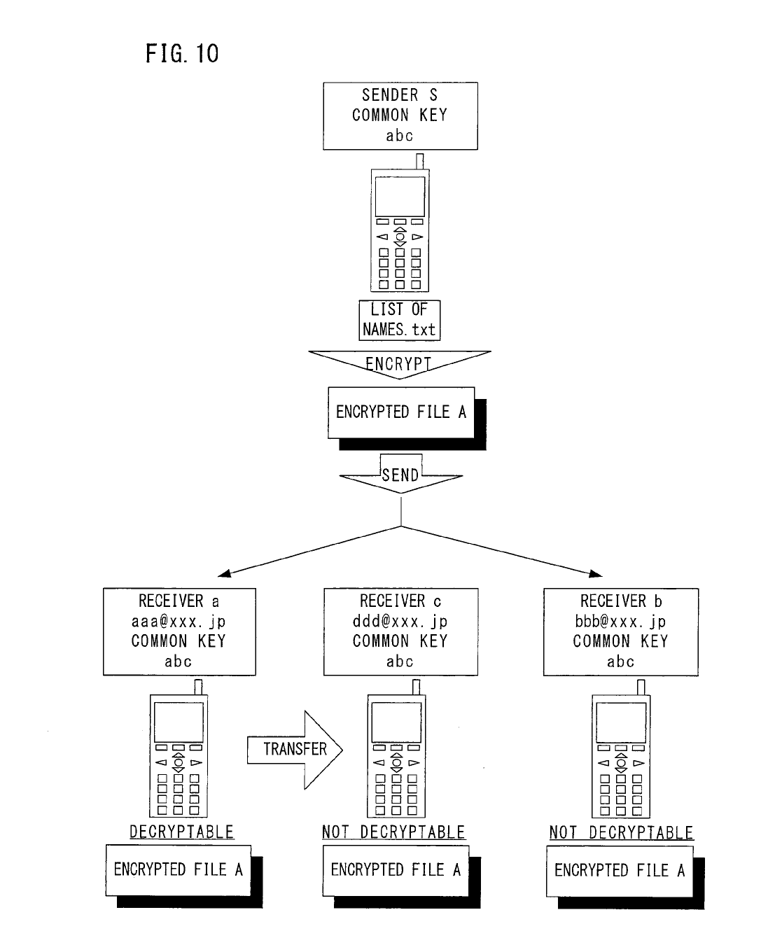

FIG. 10 is an illustrative view showing sending an encrypted file. Referring to FIG. 10, in the communication terminal 10 of a sender S, a “list of names.txt” is encrypted by an encryption key created from an e-mail address “aaa@xxx.jp” of a receiver a and a common key abc to create an encrypted file A. Then, the e-mail attached with the encrypted file A is broadcasted to the receiver a and a receiver b. In the communication terminal 10 of the receiver a which receives the e-mail attached with the encrypted file A, the encrypted file A is decrypted with a decryption key created from its own e-mail address “aaa@xxx.jp” and the common key abc, so that the receiver a can confirm the content of the “list of names.txt”.

However, in the communication terminal 10 of the receiver b which receives the e-mail attached with the encrypted file A, since the encrypted file A is decrypted with a decryption key created from an e-mail address “bbb@xxx.jp” and the common key abc, and therefore, it is impossible to make a correct decryption. That is, even if the common key abc is the same, the e-mail address is different, and therefore, it is impossible to decrypt the encrypted file A in the communication terminal 10 of the receiver b. Furthermore, in a case that the encrypted file A is transferred from the terminal 10 of the receiver a to that of the receiver c, in the communication terminal 10 of the receiver c, a decryption key is created from the e-mail address “ddd@xxx.jp” and the common key abc, but it is impossible to make decryption similar to the communication terminal 10 of the receiver b. That is, the receiver b and the receiver c cannot confirm the content of the encrypted file A.

Thus, the sender S can easily create the encrypted file A which can be decrypted only in the communication terminal 10 of the receiver a, and send it by the e-mail.

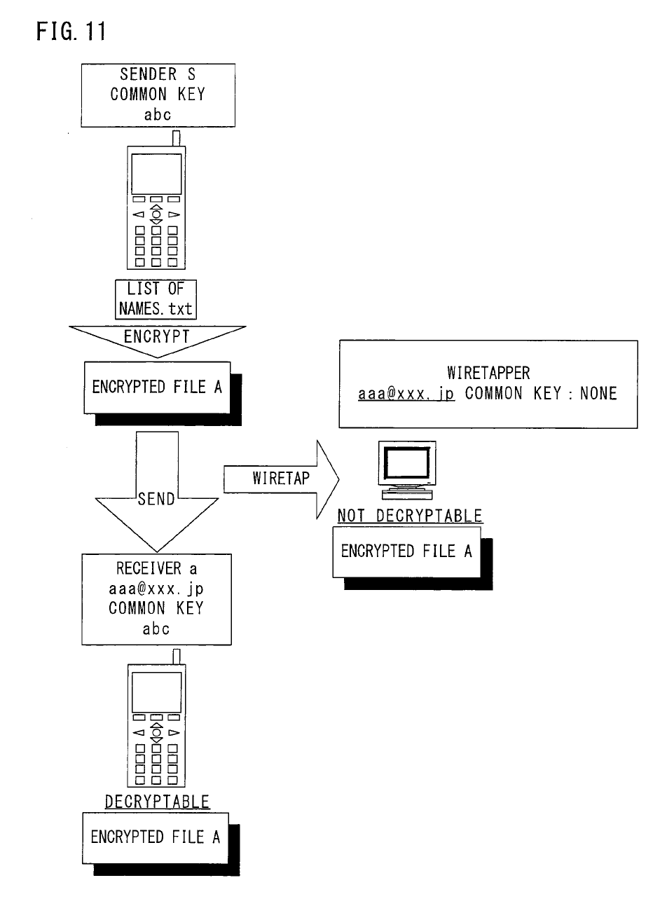

FIG. 11 is an illustrative view showing sending of the encrypted file unlike FIG. 10. Referring to FIG. 11, the communication terminal 10 of the sender S encrypts the “list of names.txt” by using the encryption key created by the common key and the e-mail address “aaa@xxx.jp” of the receiver a, and creates the encrypted file A similar to the illustrative view in FIG. 10. Then, the communication terminal 10 of the sender S sends the e-mail attached with the encrypted file A to only the receiver a. Naturally, in the communication terminal 10 of the receiver a, the encrypted file A can be decrypted, and therefore, the receiver a can confirm the content of the “list of names.txt” before encryption.

Here, a wiretapper acquires the e-mail sent from the communication terminal 10 of the sender S by wiretapping a communication pathway between the communication terminal 10 of the sender S and a mail server, etc. by using a PC, etc. That is, the wiretapper can acquire the encrypted file A, and know the e-mail address of the receiver a by analyzing the e-mail header information. However, since not knowing the algorithm of the encryption, the wiretapper cannot perform decryption processing itself. Moreover, even if the wiretapper knows the algorithm of the encryption, he or she cannot create the decryption key for want of the common key abc.

Thus, even if the encrypted file A is wiretapped by a PC, etc., the content of the encrypted file A is never known to the third party.

As understood from the above description, in the data storage area 304 of the RAM 32, the address book data 342 storing the e-mail address of opponents to be sent, the common key data 340, and the e-mail address data 338a of the own-machine are stored. According to the processing in the step S3 by the CPU 20, a file to be attached to the e-mail is selected. If the secret sending is selected by the sender, an encryption key is created from the e-mail address of the opponent to be sent and the common key by the processing in the step S13, and the selected file is encrypted according to the processing in the step S15. Then, in the processing in the step S17, the encrypted file is attached to e-mail, and in the processing in the step S21, the e-mail attached with the encrypted file is sent.

Thus, the communication terminal 10 of the sender can send the encrypted file which cannot be decrypted unless the e-mail address of the other party (receiver) decided by the sender is utilized. That is, the sender can easily create an encrypted file which is decryptable only by the other party or the opponent to be sent to whom the user wants to send, and send the encrypted file attached to the e-mail.

In addition, in the communication terminal 10 of the receiver (the other party), when the e-mail sent from the sender is received by the processing in the step S73, a decryption key is created from its own e-mail address and the common key in the processing in the step S91. In the processing in the step S93, it is possible to decrypt the encrypted attached file which is attached to the received e-mail.

Thus, the communication terminal 10 of the receiver which receives the encrypted attached file can decrypt the encrypted attached file without the need of requiring an input of a password for decryption.

### Second Embodiment

In the second embodiment, a processing when an e-mail address set to the communication terminal 10 which receives the encrypted file is changed is described. Furthermore, in the second embodiment, the configuration of the mobile terminal 10 in FIG. 1, the memory maps shown in FIG. 2, 3, and processing as to the flowchart shown in FIG. 4-8, which are used in the explanation of the first embodiment, are the same as those in the first embodiment and therefore, the duplicated explanation is omitted.

The CPU 20 executes in parallel a plurality of tasks including the address changing processing shown in FIG. 12 under the control of the RTOS (Real-time Operating System), such as “Linux” and “REX” in addition to the processing explained in the first embodiment.

When a receiver starts to change an address by using the key input device 22 of the communication terminal 10, the CPU 20 starts the address changing processing to request the change of the e-mail address in a step S111 as shown in FIG. 12. That is, a change of the e-mail address is requested to a management server which manages e-mail addresses set to the respective communication terminals 10. Then, if an approval of the change of the e-mail address is gained from the management server, the e-mail address data 338 is updated to a new e-mail address, so that the new e-mail address is registered in the management server. Then, in a step S113, the change of the e-mail address is confirmed. That is, a notification of completion of registering the new e-mail address is sent from the management server, and the notification is confirmed.

Next, in a step S115, it is determined whether or not there is an encrypted file. That is, it is determined whether or not an encrypted file is included in the data making up of the incoming mailbox data 346a. If “NO” in the step S115, that is, if there is no encrypted file, the address changing processing is ended. On the other hand, if “YES” in the step S115, authentication information is sent to the authentication server 200 (see FIG. 14) for reencryption in a step S117. That is, a connection is established with the authentication server 200 for authenticating the encryption to which the request of reencryption and the authentication information data 338c are sent. Then, in a step S119, a list of addresses used for reencryption is received. That is, when the sent authentication information data 338c is authenticated by the authentication server 200, the list of the e-mail addresses previously set in the communication terminal 10 is sent from the authentication server 200. Then, the communication terminal 10 receives the list, and disconnects the connection with the authentication server 200.

In a step S121, an encrypted file is decrypted on the basis of the list. That is, a decryption key is created from the previous e-mail address and the common key, and the encrypted file making up of the incoming mailbox data 346a is decrypted therewith. Then, in a step S123, a key for reecnryption is created. That is, an encryption key is created from the e-mail address data 338a and the common key data 340. Then, in a step S125, the decrypted file is reencrypted with the key for reencryption, and the address changing processing is ended. That is, the decrypted file decrypted in the step S121 is encrypted with the encryption key created in the step S123. Furthermore, the reencrypted file is replaced with the original encrypted file making up of the incoming mailbox data 346a. That is, the original encrypted file is updated to the reencrypted file.

FIG. 13 is a flowchart showing the authentication processing executed by a CPU 204 (see FIG. 14) of the authentication server 200. When starting the authentication processing, the CPU 204 receives authentication information from the communication terminal 10 in a step S131. That is, when the step S117 (see FIG. 12) is executed by the CPU 20 of the communication terminal 10, a connection is established with the communication terminal 10, from which authentication information is received. Succeedingly, in a step S133, it is determined whether or not the authentication information is correct. That is, it is determined whether or not the authentication information matches with the authentication information of the communication terminal 10 which is recorded in an HDD 202 included in the authentication server 200. If “NO” in the step S133, that is, if the received authentication information is not correct, authentication information is requested to the communication terminal 10 in a step S135, and then, the process returns to the step S133. That is, resending the authentication information is requested to the communication terminal 10 which has sent the authentication information. Here, the communication terminal 10 automatically sends the authentication information data 338c, but in a case that resending the authentication information is requested, the user may be forced to input the authentication information.

Furthermore, if “YES” in the step S133, that is, if the authentication information is correct, the list of the e-mail addresses which was previously used is sent in a step S137. That is, the list of the e-mail addresses which was previously set in the communication terminal 10 is sent to the communication terminal 10. Then, the connection with the communication terminal 10 is disconnected.

According to the above-described processing, when an operation of changing an address is performed in the communication terminal 10, a connection is established between the communication terminal 10 and the management server, to thereby perform address changing processing. Then, in a case that there is an encrypted file in the communication terminal 10, reencryption processing is performed. Referring to FIG. 14, the communication terminal 10 and the server 200 are connected with each other via the network 100. When the connection is established, reencryption processing is performed. That is, the communication terminal 10 sends authentication information together with a request of reencryption to the server 200 in a case that there is an encrypted file. Then, the server 200 sends to the communication terminal 10 the list of the e-mail address which was previously set to the communication terminal 10. After the communication terminal 10 disconnects the connection with the authentication server 200, it reencrypts the encrypted file.

Thus, even if the e-mail address is changed, since reencryption is made by means of the changed e-mail address, the encrypted file can be decrypted, improving the usefulness of the receiver.

### Third Embodiment

In the third embodiment, sending processing of an encrypted file by a short distance radio communication according to the Bluetooth standard is explained. Furthermore, in the third embodiment, the configuration of the mobile terminal 10 in FIG. 1 and the memory maps shown in FIG. 2, 3, which are used for explanation of FIG. 1 embodiment, are the same as those in the first embodiment, and therefore, the duplicated explanation thereof is omitted. It should be noted that the short distance radio communication may be other standards included in a WLAN (Wireless Local Area Network) or a WPAN (Wireless Personal Area Network) defined by the IEEE 802 committee without being limited to the Bluetooth standard. For example, the WLAN includes the Wi-Fi standards of the IEEE 802.11 standards, and the WPAN includes Zigbee (registered trademark) standards of IEEE 802.15 standard. [00151] With respect to the flowcharts shown in FIG. 4-8, the flow of the processing is the same, but an encryption key and a decryption key are created from the common key data 340 and the Bt appliance information data 338b in place of the e-mail address data 338a. Furthermore, in the short distance radio communication, the encrypted file is directly sent and received. Therefore, e-mail as a history of sending is not stored, and only the sent filename is recorded as history information.

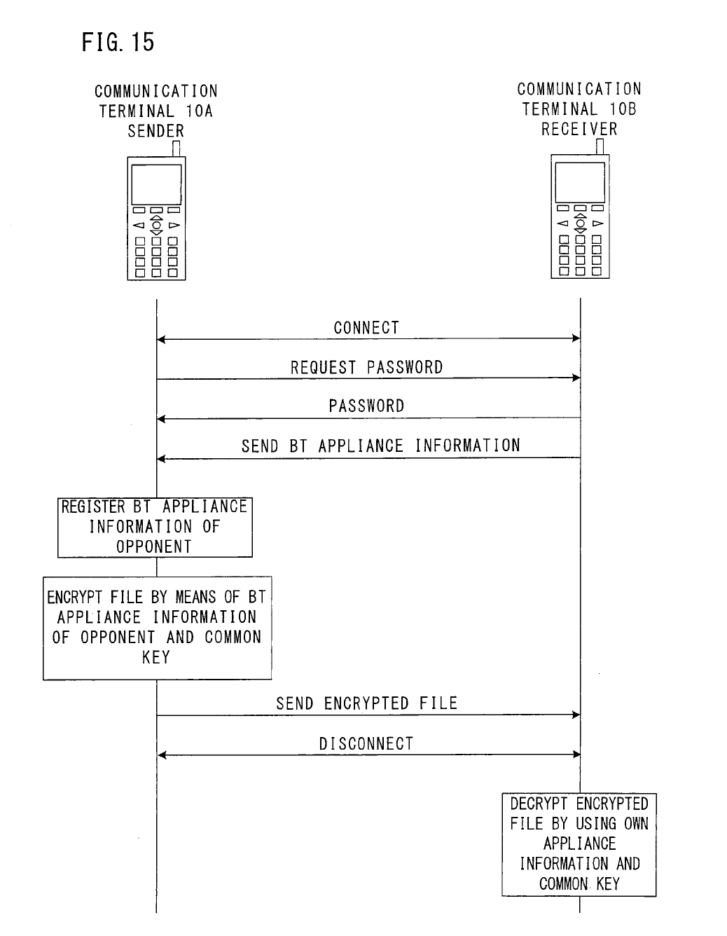

In the short distance radio communication, an initial registration of a communication partner is required, and therefore, the procedure of the initial registration in the short distance radio communication is explained. Referring to FIG. 15, when an initial registering operation of the short distance radio communication is performed in a communication terminal 10 of a sender A (hereinafter, referred to as a terminal 10A), and a wait state of the initial registration is set in a communication terminal 10 of a receiver B (hereinafter, referred to as a terminal 10B), a connection setting (pairing) is performed between the terminals 10A and 10B. When a connection is established, authentication processing by means of a password is performed. That is, the terminal 10A requests the terminal 10B to send the password while the terminal 10B responds the password to the terminal 10A. The terminal 10A determines whether or not the password set to itself and the password received from the terminal 10B match with each other, and if the determination result indicates matching, the connection is retained while if the determination result indicates mismatching, the connection is canceled.

Additionally, the terminal 10B sends the password and the Bt appliance information data 334b to the terminal 10A. The terminal 10A registers the received Bt appliance information of the terminal 10B in an address book. Then, the terminal 10A creates an encryption key from the Bt appliance information of the terminal 10B and the common key data, encrypts the file to be sent, and sends the same to the terminal 10B. When sending the encrypted file to be sent is completed, the terminal 1OA disconnects the connection via the short distance radio communication. The terminal 10B creates a decryption key from its own Bt appliance information and the common key information, and decrypts the received encrypted file.

Noted that the processing shown in FIG. 4-FIG. 6 may be executed by the CPU of the PC, but the decryption processing is not executed in the PC. This is for preventing a decrypted file from being flown out due to the easiness of storing or copying the decrypted file in the PC. Furthermore, the communication terminal 10 in which the file encryption /decryption software is not set up may newly set up or update software by downloading it from the server. In addition, the data to be encrypted may be a file in other formats, such as an image file and a music file, etc. in addition to the text data (file).

Additionally, the W-CDMA standard, the TDMA standard, the PHS standard, and GSM standard may be adopted as a communication system for the communication terminal 10 without it being limited to the CDMA standard. Without limiting the terminal to only the communication terminal 10, handheld terminals such as PDA (Personal Digital Assistant), etc. may be applicable.

Although the present invention has been described and illustrated in detail, it is clearly understood that the same is by way of illustration and example only and is not to be taken by way of limitation, the spirit and scope of the present invention being limited only by the terms of the appended claims.

1. A communication terminal, comprising:
a memory for storing common key information set with a communication terminal of an opponent and unique information of said opponent;
a selector for selecting a file to be sent;
a first encryption key creator for creating a first encryption key from the unique information of said opponent and said common key information;
an encrypted file creator for creating an encrypted file from the file selected by said selector by utilizing the encryption key created by said first encryption key creator; and
a sender for sending the encrypted file created by said encrypted file creator to said communication terminal of said opponent.

2. A communication terminal according to claim 1, further comprising an attacher for attaching the encrypted file created by said encrypted file creator to e-mail as an attached file, wherein said sender sends the e-mail to which the encrypted file is attached by said attacher to said communication terminal of said opponent.

3. A communication terminal according to claim 2, further comprising a historical mail storage for storing the e-mail attached with the encrypted file which is sent by said sender as a historical mail.

4. A communication terminal according to claim 2, further comprising:
a selected file temporary storage for temporarily storing the file selected by said selector;
a selected-file attacher for attaching said selected file stored by said selected file temporary storage to the historical mail stored by said historical mail storage; and
an encrypted file deleter for deleting the encrypted file of the historical mail stored by said historical mail storage.

5. A communication terminal according to claim 2, wherein
said encryption key creator includes a second encryption key creator for, in a case of a plurality of opponents for sending, creating a second encryption key which can be decrypted with unique information of each of the opponents; and
said sender broadcasts one e-mail attached with a encrypted file encrypted by using the second encryption key created by said second encryption key creator to said respective communication terminals of said opponents.

6. A communication terminal according to claim 1, wherein said memory further stores unique information of its own machine, further comprising:
a receiver for receiving the encrypted file sent from the communication terminal of the opponent;
a decryption key creator for creating a decryption key from the unique information of its own machine and said common key information; and
a decrypted file creator for creating a decrypted file from said encrypted file received by said receiver by using the decryption key created by said decryption key creator.

7. A communication terminal according to claim 6, further comprising:
a decrypted file temporary storage for temporarily storing the decrypted file decrypted by said decrypted file creator;
a display for displaying the decrypted file temporarily stored by said decrypted file temporary storage; and
a decrypted file deleter for deleting the decrypted file temporarily stored by said temporary storage when an end of display by said display is detected.

8. A communication terminal according to claim 6, wherein said memory stores a first personal identification number, and further comprising a personal identification number requester for requesting a second personal identification number after the encrypted file is received by said receiver, wherein said decryption key creator creates a decryption key when the second personal identification number obtained by said personal identification number requester matches with said first personal identification number.

9. A communication terminal according to claim 6, further comprising a storage for storing the e-mail attached with the encrypted file which is received by said receiver.

10. A storage medium readably storing, by a processor of a communication terminal, a communication terminal controlling program of said communication terminal including a memory storing common key information set with an opponent and unique information of said opponent, said communication terminal controlling program causes said processor to function as:
a selector for selecting a file to be sent;
an encryption key creator for creating a encryption key from the unique information of said opponent and said common key information;
an encrypted file creator for creating an encrypted file from the file selected by said selector by utilizing the encryption key created by said encryption key creator; and
a sender for sending the encrypted file created by said encrypted file creator to said communication terminal of the opponent.

11. A storage medium storing a communication terminal controlling program according to claim 10, wherein said memory further stores unique information of its own machine, said communication terminal controlling program causes a processor to further function as:
a receiver for receiving an encrypted file sent from the communication terminal of the opponent;
a decryption key creator for creating a decryption key from said unique information of its own machine and said common key information; and
a decrypted file creator for creating a decrypted file from said encrypted file received by said receiver by utilizing the decryption key created by said decryption key creator.

12. A communication terminal controlling method including a memory storing common key information set with a communication terminal of an opponent and unique information of said opponent, comprising the steps of:
selecting a file to be sent;
creating an encryption key from the unique information of said opponent and said common key information;
creating an encrypted file from the file selected by said selecting step by utilizing an encryption key created by said encryption key creating step; and
sending the encrypted file created by said encrypted file creating step to said communication terminal of the opponent.

13. A controlling method according to claim 12, wherein said memory further stores its own unique information, further comprising the steps of:
receiving an encrypted file sent from the communication terminal of the opponent;
creating a decryption key from said unique information of its own machine and said common key information; and
creating a decrypted file from said encrypted file received by said receiving step by utilizing the decryption key created by said decryption key creating step.

14. A storage medium readably storing, by a processor of a PC, a communication controlling program of the PC including a memory storing common key information set with a communication terminal of an opponent and unique information of said opponent, said communication controlling program causes a processor of said PC to function as:
a selector for selecting a file to be sent;
an encryption key creator for creating a encryption key from the unique information of said opponent and said common key information;
an encrypted file creator for creating an encrypted file from the file selected by said selector by utilizing the encryption key created by said encryption key creator; and
a sender for sending the encrypted file created by said encrypted file creator to said communication terminal of the opponent.

15. An authentication system including a server managing reencryption processing of an encrypted file and a communication terminal:
said communication terminal comprising:
a change confirmer for confirming a change of the unique information of said own machine stored by said memory;
an authentication information sender for sending authentication information for reencryption of said encrypted file when it is confirmed that the unique information of said own machine is changed by said change confirmer, and an encrypted file is stored by said storage;
a list receiver for receiving a list of the unique information set to the own machine which is sent from said server in response to said authentication information sender sending the authentication information;
a decrypted-file-for-reencryption creator for creating a decrypted file for reencryption from the encrypted file stored in said storage on the basis of the list received by said list receiver;
a reencryption key creator for creating a reencryption key by utilizing the changed unique information of said own machine stored in said memory and said common key information; and
a reencrypted file creator for creating a reencrypted file from the decrypted file for reencryption created by said decrypted-file-for-reencryption creator by utilizing the reencryption key created by said reencryption key creator, and
said server, comprising
a list sender for sending the list of the unique information set to the communication terminal when authentication information sent from said communication terminal is correct.
